(19) United States
(12) Patent Application Publication
(10) Pub. No.: US 2002/0077057 A1
(43) Pub. Date: Jun. 20, 2002

(54) Exhaust removal system

(76) Inventor: Robert Frink, Rock Island, IL (US)

Correspondence Address: James B. Eagle, Eagle & Eagle, Attorneys at Law, 224 18th Street, Suite 200, Rock Island, IL, 61201, US

(21) Appl. No.: 09/740,172

(22) Filed: Dec. 18, 2000

(51) Int. Cl. F24F 7/00; F24F 11/00; F23J 11/00; F24F 13/00; B08B 15/02; F24C 15/20

(52) U.S. Cl. 454/63

(57) ABSTRACT

The present invention is an exhaust removal system designed for buses and semis. The telescoping mast with the capture nozzle allow the user to nestle the capture nozzle over the vehicle exhaust stack by simply rolling the unit into position. This obviates the need for a ladder or crawling around on the vehicle prior to the vehicle being repaired in a garage. Once the unit is in place a swivel joint allows the operator to exhaust to the left or the right. This makes it easier to direct the exhaust outdoors, or to an exhaust header, as the case may be.

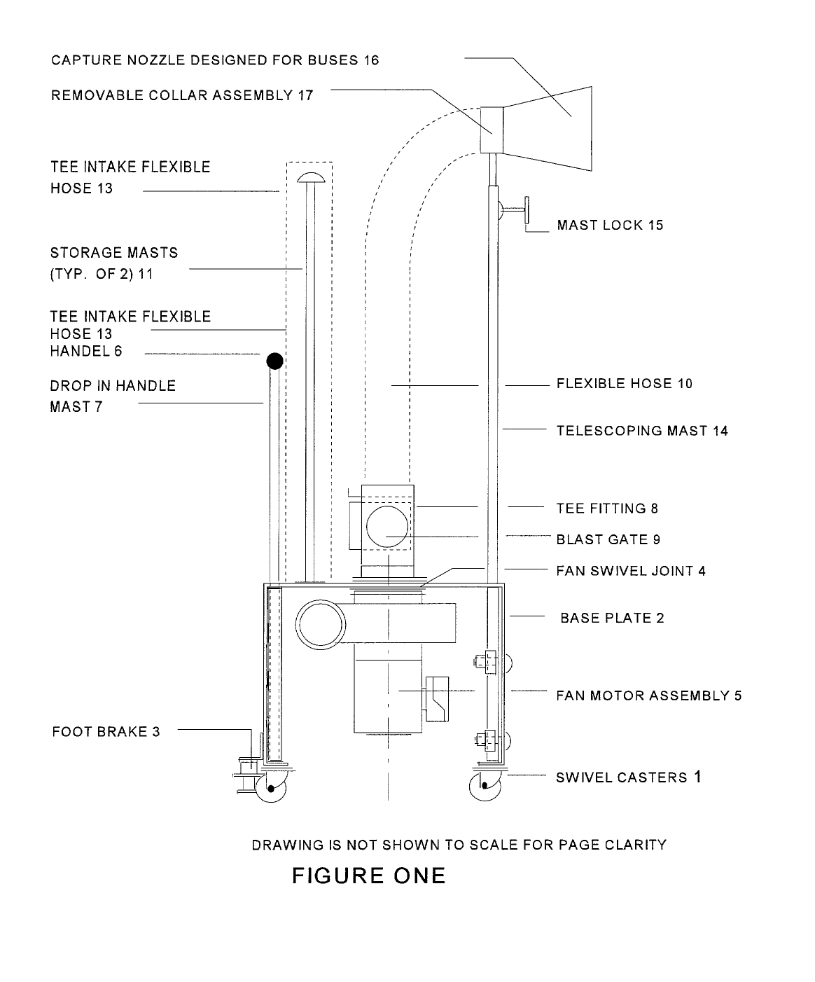

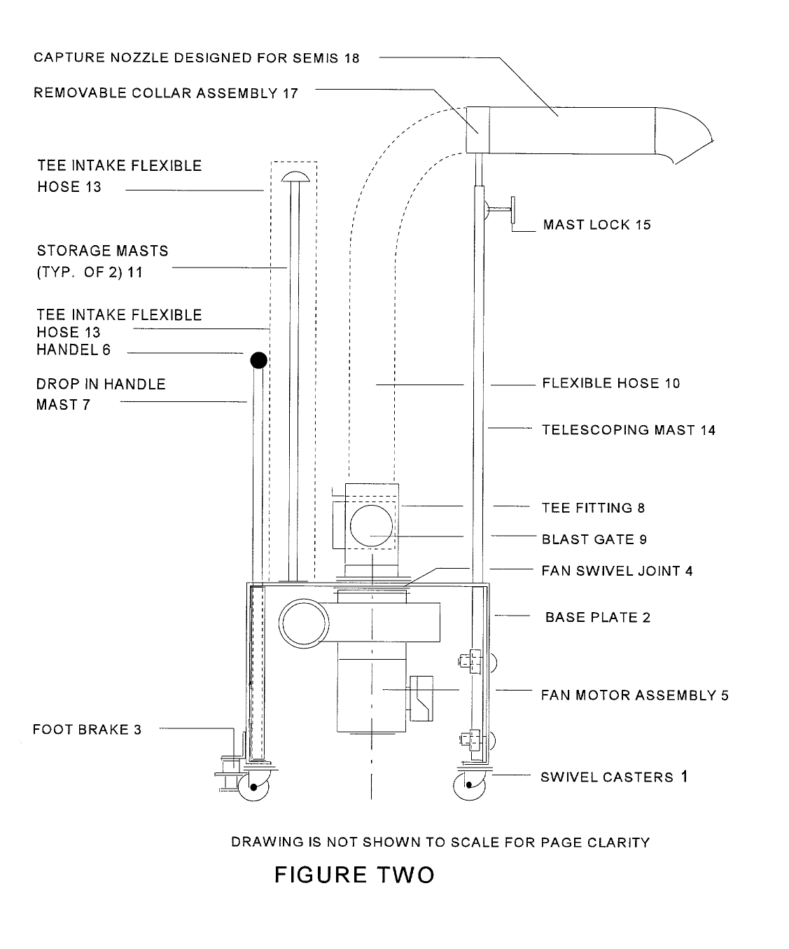

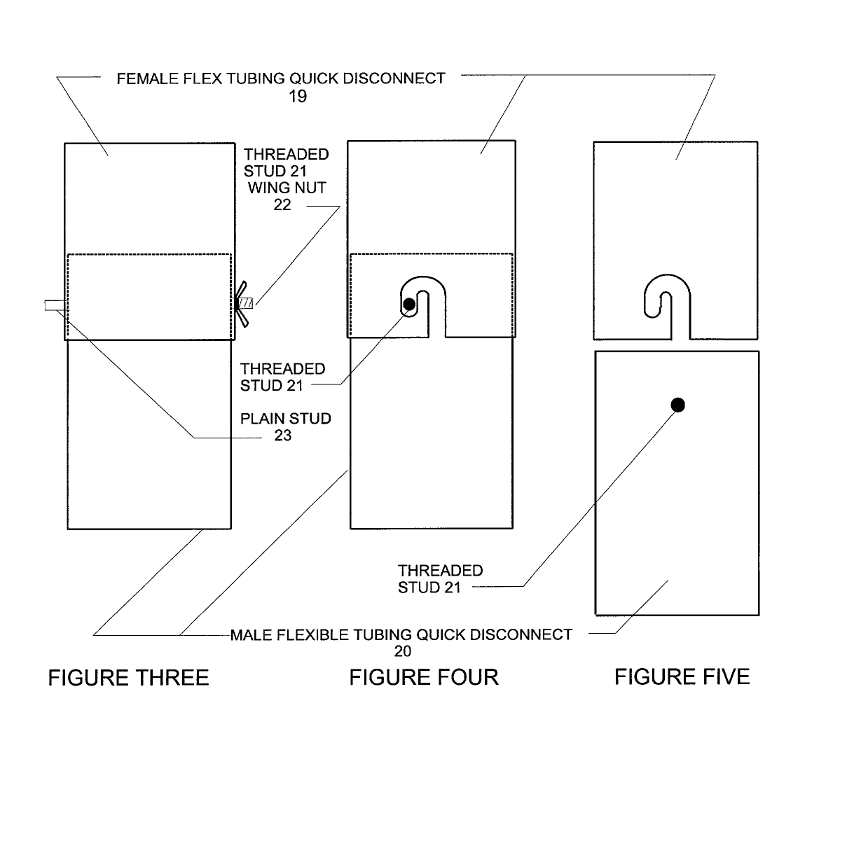

### BACKGROUND OF THE INVENTION

1. Field of the Invention

This invention relates to an exhaust removal system, specifically an exhaust removal system which is portable and would typically be used in a large garage where repairs are performed on buses or semi-trucks. A fan is connected to the portable unit by means of a fan swivel joint which allows exhaust gases to be discharged in any direction. Also, a capture nozzle is provided which obviates the need for a technician to climb up on the vehicle being serviced.

2. Description of Related Art Including Information Disclosed Under 37 CFR 1.97 and 1.98

The Avery patent (U.S. Pat. No. 1,390,950) is a header with flexible tubes disposed thereon. Means are provided for fastening the said flexible tubes to the tailpipe of a car and a pulley and weight system is provided for automatically hanging the flexible tube high and out of the way.

The Edge patent (U.S. Pat. No. 1,405,106) is “a protective devise for preventing the inter inhalation of breath as between a dentist and patient, whereby to avoid disagreeable conditions, at times occasioned.” In other words, the Edge patent is a pump (or fan) with tubing attached to the suction end of the pump and a stand to secure the tubing in a variety of locations.

The Johnson patent (U.S. Pat. No. 2,162,019) is a dust removing apparatus attached to a fixed mast having an arm (suction tube) that rotates and moves up and down.

The Coral patent (U.S. Pat. No. 4,158,462) is a series of rigid tubes connected together by articulation units comprising brackets and flexible tubes connected to the rigid tubes with a collar.

The Tada patent (U.S. Pat. No. 4,446,861) involves a purification system for a dentist office. Suction is taken changeably either from the floor area, or from a suction hood. The suction hood is attached to piping which is attached to an articulating arm. Said suction piping is rotatably connected to a fan and the fan discharges to the outside.

The Bertelsen patent (U.S. Pat. No. 4,690,042) is an air purifier for high speed paper handling machines in computer rooms. A hood, or wing, with baffles is placed over the discharge vent of the copier or paper handling machine and a fan then sucks the discharged air and cycles it through a filter and then back in to the room.

The Vannier patent (U.S. Pat. No. 5,487,766) is large air filtration system used in conjunction with car painting activities. Air is sucked through a filter and exhausted through an exhaust filter and over the body of the care being painted.

### BRIEF SUMMARY OF THE INVENTION

The present invention is a portable and compact unit for discharging exhaust gases from vehicles (especially buses and semis) while they are being repaired. A telescoping mast is provided which can adjust to any height. A capture nozzle is connected to the end of the flexible hose and positioned over the exhaust pipe using said telescoping mast.

The unit is on four wheels with a handle similar to a hand cart. A fan is provided for drawing exhaust gas from the vehicle and discharging the exhaust gas out of the building either by placing the flexible exhaust hose outside or hooking it up to a stationary header (provided in some garages for that purpose) which header then discharges the exhaust gas to the outside.

Another unique aspect of this invention is the swivel connection whereby the fan motor can swivel after the sleeve is in place (i.e. attached to the vehicle exhaust pipe). This swivel joint allows the motor to discharge right or left thereby minimizing the length of flexible exhaust hose required and providing for easy discharge hose connection.

### BRIEF DESCRIPTION OF THE SEVERAL VIEWS OF THE DRAWINGS

FIGURE ONE is a side view of the unit with a capture nozzle designed for buses.

FIGURE TWO is a side view of the unit with a capture nozzle designed for semis.

FIGURE THREE is a side view of a quick disconnect, assembled.

FIGURE FOUR is a front view of a quick disconnect, assembled and without the wing nut.

FIGURE FIVE is a front view of a quick disconnect, unassembled and without the wing nut.

### DETAILED DESCRIPTION OF THE INVENTION

Referring to FIGS. ONE and TWO four swivel casters 1 are mounted on a base plate 2. A foot brake 3 is also mounted on said base plate 2 to keep the system from rolling while in use. The base plate 2 is preferably made from a 1/4″ thick metal sheet (two feet wide) with two 90° bends to form an upside down “U” shape or three sides of a box. A hole is provided in said base plate 2 in its horizontal member to accommodate a fan swivel joint 4. A fan-motor assembly 5 is connected to the bottom of the fan swivel joint 4 to allow easy rotation of the fan-motor assembly 5. A handle 6 is also attached to the base plat 2. Said handle 6 could be retractable by installing a drop in handle mast 7 on the base plate 2. A tee fitting 8 with a blast gate 9 could be installed above the fan swivel joint 4 to accommodate/accept a tee intake flexible hose 13 (shown in storage) which is coming from an under chassis tail pipe found in most cars and vans. A flexible hose 10 is attached to the tee fitting 8 and should be eight to ten feet in length.

Two storage masts 11 are attached to the base plate 2. One storage mast 11 is for storing the discharge flexible hose 12 (not shown) and the other storage mast 11 is for storing the tee intake flexible hose 13. Said storage masts 11 can be straight, as shown, or bent at an angle (approximately 45°) half way along their length.

A telescoping mast 14 is also attached to the base plate 2. Once the telescoping mast 14 is adjusted to the desired height, a mast lock 15 can secure the telescoping mast 14 at that height.

Referring specifically to FIG. ONE, a capture nozzle designed for buses 16 is attached to the telescoping mast 14 by means of a removable collar assembly 17 and connected to the flexible hose 10.

Referring specifically to FIG. TWO, a capture nozzle designed for semis 18 is attached to the telescoping mast 14 and connected to the flexible hose 10.

Referring specifically to FIGS. THREE, FOUR and FIVE, the three flexible hoses (flexible hose 10, tee intake flexible hose 13 and discharge flexible hose 12) should be six inches in diameter and equipped with a female flex tubing quick disconnect 19, the capture nozzle designed for buses 16 (or the capture nozzle designed for semis 18, as the case may be) and the discharge of the fan-motor assembly 5 and both intakes to the tee fitting 8 should be equipped with a male flex tubing quick disconnect 20. The male flex tubing quick disconnect 20 should have a threaded stud 21 welded thereon in order to accept a wing nut 22 in order to lock the female flex tubing quick disconnect 19 into place. Opposite the threaded stud 21, the male flex tubing quick disconnect 21 should also contain a plaint stud 23. The female tubing quick disconnect 19 should have two “J” cut-outs in order to accept the plain stud 23 and the threaded stud 21 simultaneously.

A retractable electric cord 24 (not shown) could also be attached to the base plate 2.

Also, for simplicity, if only one vehicle will be worked on at a time, the tee fitting 8 can be omitted and just replaced with a male flex tubing quick disconnect 20.

I claim:

1. An exhaust removal system comprising:
an intake hose;
a fan with an intake and an exhaust wherein said fan intake is swivelly connected to said intake hose; and,
an exhaust hose connected to said fan exhaust.

2. An exhaust removal system comprising:
a hose;
a capture nozzle attached to said hose; and,
a telescoping mast attached to said capture nozzle, said telescoping mast having a base.

3. The exhaust removal system in claim 1 wherein the intake hose is attached to a capture nozzle; and,
said capture nozzle is attached to a telescoping mast having a base.
